(19) United States
(12) Patent Application Publication
(10) Pub. No.: US 2002/0063705 A1
(43) Pub. Date: May 30, 2002

(54) Apparatus and method for drawing three dimensional graphics by controlling alpha value based on Z coordinate value

(75) Inventors: Shohei Moriwaki, Hyogo (JP); Yoshifumi Azekawa, Hyogo (JP); Osamu Chiba, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/892,773

(22) Filed: Jun. 28, 2001

(30) Foreign Application Priority Data
Nov. 28, 2000 (JP) 2000-361405 (P)

(51) Int. Cl. G06T 15/40

(52) U.S. Cl. 345/422

(57) ABSTRACT

In the three-dimensional graphics drawing apparatus, a color register has an α register in which a Z-coordinate value of an object is set as its α value. A drawing unit draws the object based on coordinate data stored in a coordinate register and color data stored in the color register. Accordingly, the degree of transparency of a drawing object that is closer to the front increases, and a portion that is hidden behind the drawing object becomes apparent. Visibility is thus increased.

### BACKGROUND OF THE INVENTION

1. Field of the Invention

The present invention relates to a technique for drawing an object in three-dimensional graphics. More particularly, the present invention relates to three-dimensional graphics drawing apparatus and method for drawing an object by controlling an α value, representing transmittance of the object, and RGB (Red, Green, Blue) values, being color data of the object, based on its Z-coordinate value.

2. Description of the Background Art

Recently, in order to enable output of realistic and delicate images on a car navigation system and the like, three-dimensional graphics drawing apparatuses performing three-dimensional image processing at high speed have been increasingly utilized. In a conventional three-dimensional graphics drawing apparatus, RGB values as color data and an α value representing transmittance of an object to be drawn (or, a drawing object) are predetermined, and the object is drawn referring to these values.

In the conventional three-dimensional graphics drawing apparatus, however, the RGB and α values of a drawing object have been invariable. Therefore, when a viewpoint comes closer to the drawing object as in the car navigation system and the user wants to know the detail around the drawing object, other objects hidden behind the relevant drawing object cannot be displayed, which results in poor visibility.

### SUMMARY OF THE INVENTION

An object of the present invention is to provide an apparatus and a method for drawing three-dimensional graphics improved in visibility.

Another object of the present invention is to provide an apparatus and a method for drawing three-dimensional graphics allowing reduction in amount of drawing data.

A further object of the present invention is to provide an apparatus and a method for drawing three-dimensional graphics realizing a visual effect like whiteout or blackout.

According to an aspect of the present invention, a three-dimensional graphics drawing apparatus drawing an object based on color data and coordinate data is provided, which includes: a transmittance setting unit that sets transmittance of the object based on a depth coordinate value included in the coordinate data; and a drawing unit that draws the object based on the color data including the transmittance set by the transmittance setting unit and the coordinate data.

The transmittance setting unit sets the transmittance of the object based on the depth coordinate value included in the coordinate data. Thus, it is unnecessary to include the transmittance in the drawing data, and the data amount of the drawing data can be reduced.

According to another aspect of the present invention, a three-dimensional graphics drawing apparatus drawing an object based on color data and coordinate data including a depth coordinate value is provided, which includes: a color register that stores the color data of the object; a color data setting unit that sets the color data of the object in the color register when the depth coordinate value of the object is not greater than a threshold value, and that sets a prescribed value in the color register when the depth coordinate value of the object exceeds the threshold value; and a drawing unit that draws the object based on the color data stored in the color register and the coordinate data.

Since the color data setting unit sets a prescribed value in the color register when the depth coordinate value of an object exceeds a threshold value, any drawing object located deeper than a prescribed position is not displayed. Thus, it becomes possible to obtain a visual effect like whiteout or blackout.

According to a further aspect of the present invention, a three-dimensional graphics drawing method for drawing an object based on color data and coordinate data is provided, which includes a step of setting transmittance of the object based on a depth coordinate value included in the coordinate data; and a step of drawing the object based on the color data including the transmittance set in the setting step and the coordinate data.

Since the transmittance of the object is set based on the depth coordinate value included in the coordinate data, it is unnecessary to include the transmittance in the drawing data. Accordingly, the amount of drawing data can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic configuration of a three-dimensional graphics drawing apparatus according to a first embodiment of the present invention.

FIG. 2 is a block diagram illustrating a detailed configuration of the drawing unit 3 in FIG. 1.

FIG. 3A shows exemplary objects drawn by a conventional three-dimensional graphics drawing apparatus, and FIG. 3B shows the corresponding objects drawn by the three-dimensional graphics drawing apparatus according to the first embodiment of the present invention.

FIG. 4 is a block diagram showing a schematic configuration of a three-dimensional graphics drawing apparatus according to a second embodiment of the present invention.

FIG. 5A shows exemplary objects drawn by a conventional three-dimensional graphics drawing apparatus, and FIG. 5B shows the corresponding objects drawn by the three-dimensional graphics drawing apparatus according to the second embodiment of the present invention.

FIG. 6 is a block diagram showing a schematic configuration of a three-dimensional graphics drawing apparatus according to a third embodiment of the present invention.

FIG. 7A shows exemplary objects drawn by a conventional three-dimensional graphics drawing apparatus, and FIG. 7B shows the corresponding objects drawn by the three-dimensional graphics drawing apparatus according to the third embodiment of the present invention.

### DESCRIPTION OF THE PREFERRED EMBODIMENTS

First Embodiment

In the three-dimensional graphics drawing apparatus according to the first embodiment, a Z-coordinate value being depth information of an object is substituted for an α value representing its transmittance, so that a drawing object on a display image plane becomes more transparent as its Z-coordinate value becomes smaller, i.e., the drawing object comes closer to the front. Here, the Z-coordinate value is set to “0” at the front, and made to increase as the depth increases.

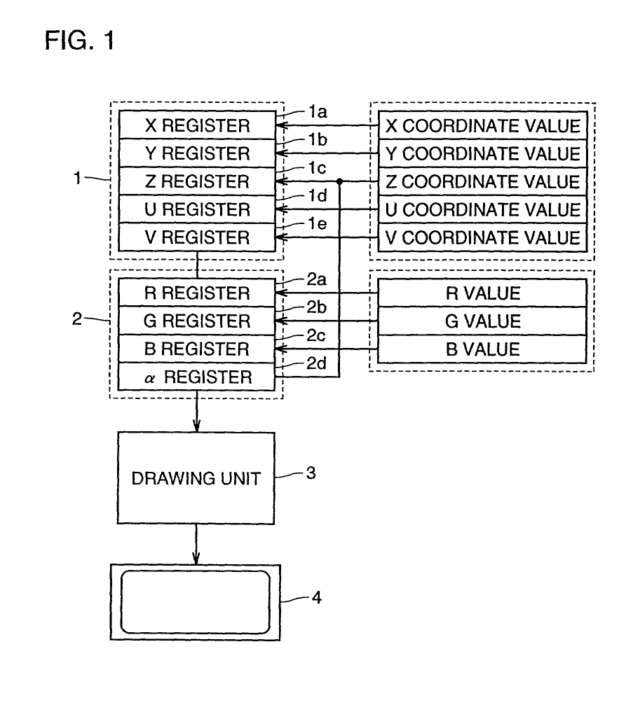

Referring to FIG. 1, the three-dimensional graphics drawing apparatus according to the first embodiment includes: a coordinate register 1 in which coordinate values of a drawing object are stored; a color register 2 in which color data of the drawing object is stored; a drawing unit 3 that draws the object based on the coordinate data stored in coordinate register 1 and the color data stored in color register 2; and a display unit 4 that displays the object drawn by drawing unit 3.

Coordinate register 1 includes: an X register 1a in which an X-coordinate value of the drawing object is stored; a Y register 1b in which a Y-coordinate value of the drawing object is stored; a Z register 1c in which a Z-coordinate value of the drawing object is stored; a U register 1d in which a U-coordinate value in texture mapping coordinates of the drawing object is stored; and a V register 1e in which a V-coordinate value in the texture mapping coordinates of the drawing object is stored.

Color register 2 includes: an R register 2aa in which an R value of the drawing object is stored; a G register 2b in which a G value of the drawing object is stored; a B register 2c in which a B value of the drawing object is stored; and an α register 2d in which the Z-coordinate value of the drawing object is stored as an α value.

The coordinate data and the color data of the drawing object are read by an external device, e.g., a compact disc-read only memory (CD-ROM) drive with a CD-ROM mounted therein, and are set to coordinate register 1 and color register 2, respectively.

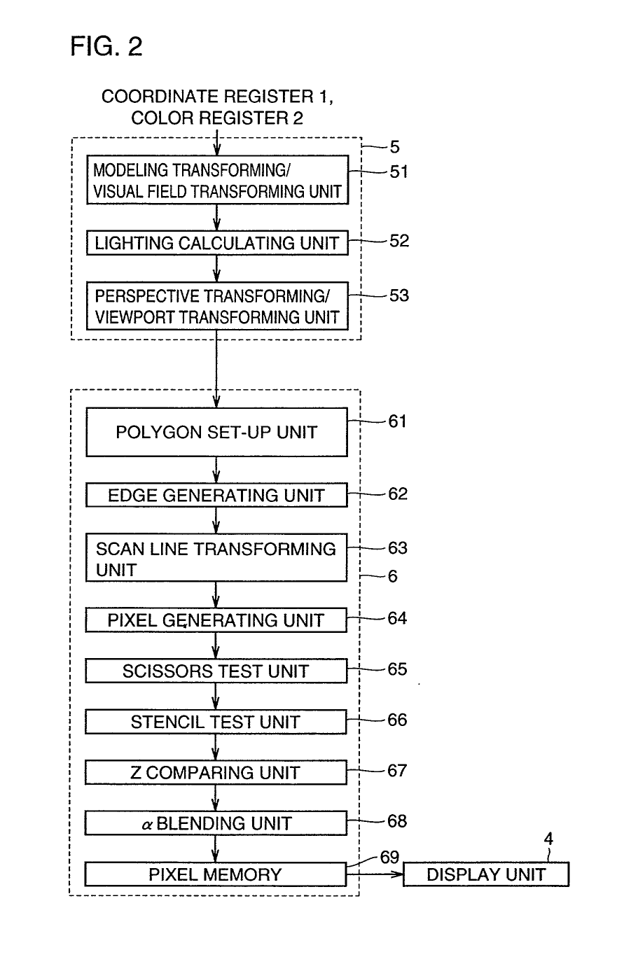

Referring to FIG. 2, drawing unit 3 shown in FIG. 1 includes: a geometrical operation unit 5 that performs a series of geometrical operations on three-dimensional polygon data constituting the drawing object; and a three-dimensional drawing unit 6 that performs a series of drawing processes based on vertex data having been operated and output from geometrical operation unit 5.

Geometrical operation unit 5 performs geometrical operations on the three-dimensional polygon data, and provides coordinate-transformed vertex data of each polygon constituting a primitive, e.g., vertex coordinate data, onto a viewport.

Three-dimensional drawing unit 6 generates pixel data of each polygon constituting the primitive based on the vertex coordinate data output from geometrical operation unit 5, and writes the generated pixel data to a pixel memory. Once the pixel data corresponding to one frame has been written into the pixel memory by three-dimensional drawing unit 6, display unit 4 reads the pixel data out of the pixel memory and displays the data successively.

Geometrical operation unit 5 includes: a modeling transforming/visual field transforming unit 51 that first defines a three-dimensional shape to be drawn in a modeling coordinate system and transforms that into a world coordinate system so that the shape is arranged in a space, and further determines projection conditions for the three-dimensional shape, including a position of viewpoint and a direction of visual line, so that the three-dimensional shape is transformed into that in a visual area; a lighting calculating unit 52 that calculates brightness of lighting of the three-dimensional shape having been modeling-transformed and visual field-transformed by modeling transforming/visual field transforming unit 51; and a perspective transforming/viewport transforming unit 53 that performs perspective transformation of the three-dimensional shape as an object and transforms the visual area to a viewport.

Three-dimensional drawing unit 6 includes: a polygon set-up unit 61 that calculates a difference of vertex coordinates of a polygon and outputs an inclination between vertexes of the polygon; an edge generating unit 62 that refers to the inclination between the vertexes of the polygon output from polygon set-up unit 61 to generate an edge between the vertexes of the polygon; a scan line transforming unit 63 that transforms each polygon pixel by pixel, based on the edge of the polygon generated by edge generating unit 62; a pixel generating unit 64 that generates pixel data in each polygon; a scissors test unit 65 that deletes pixels out of range of a display frame; a stencil test unit 66 that determines whether each pixel is an object of drawing; a Z comparing unit 67 that compares Z values of the polygons to determine whether each polygon is to be drawn on the display image plane; an α blending unit 68 that refers to an α value representing a degree of transparency to synthesize color data of succeeding polygons; and a pixel memory 69 that stores the generated pixel data as a frame image.

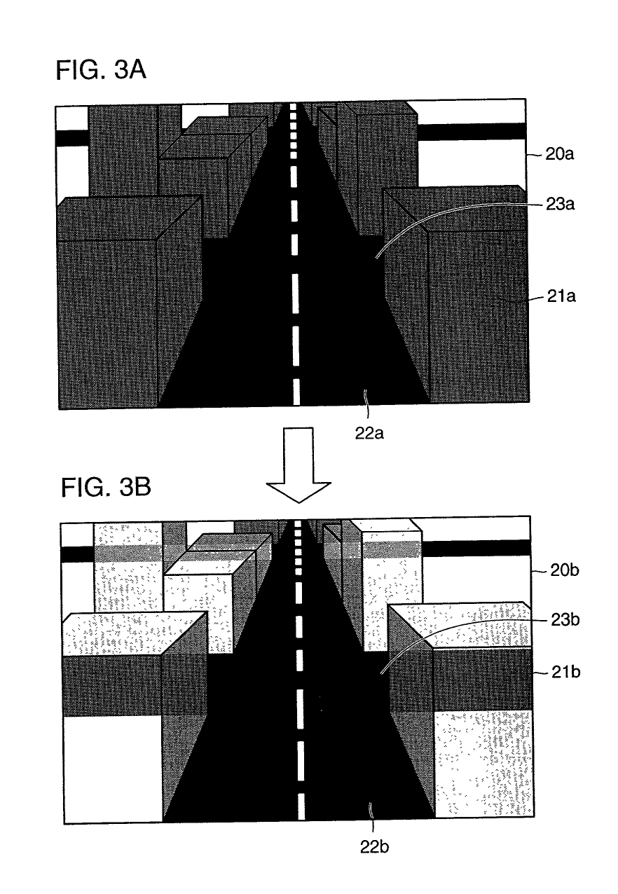

FIG. 3A shows, by way of example, objects drawn by a conventional three-dimensional graphics drawing apparatus. Buildings and roads, including a building 21a and a road 22a, are displayed as the drawing objects on a display image plane 20a. In the conventional three-dimensional graphics drawing apparatus, the α values of the drawing objects are predetermined. Thus, the detail of the road 23a behind the building 21a, for example, is not displayed.

FIG. 3B shows the corresponding objects drawn by the three-dimensional graphics drawing apparatus according to the present embodiment. On the display image plane 20b, buildings including a building 21b and roads including a road 22b the user is currently following are displayed as the drawing objects. In the three-dimensional graphics drawing apparatus of the present embodiment, the Z-coordinate value of each drawing object is set as its α value. Therefore, as the drawing object comes closer to the front, its α value decreases, and accordingly, the degree of transparency thereof increases. For example, the detail around the road 23b hidden behind the building 21b becomes visible through building 21b on the display image plane.

In the description above, the Z-coordinate value has been substituted for the α value. More generally, however, the α value may be defined as a monotone increasing function of the Z-coordinate value to obtain the similar effect. For example, if the α value is defined as a linear function of the Z-coordinate value with a positive coefficient, it becomes possible to increase or decrease a ratio of a change of the α value with respect to a change of the Z-coordinate value. Thus, the degree of transparency of a drawing object, or visibility of an object hidden behind the drawing object, can be set more appropriately. In addition, the Z-coordinate value can be set to “0” at the back and made to increase as the depth decreases. In this case, a reciprocal of the Z-coordinate value can be set as the α value.

As explained above, according to the three-dimensional graphics drawing apparatus of the present embodiment, a drawing object is drawn by setting the Z-coordinate value of the drawing object as its α value. Thus, when a viewpoint comes closer to the drawing object, other drawing objects hidden behind the relevant drawing object comes to be seen through the drawing object on the display image plane, so that visibility improves. In addition, since the Z-coordinate value is used as the α value of the drawing object, it is unnecessary to retain the cc value for every drawing object. This reduces the amount of the drawing data. Further, the effects as described above are guaranteed even for a drawing object originally lacking the α value.

Second Embodiment

In the three-dimensional graphics drawing apparatus according to the second embodiment, a Z-coordinate value of a drawing object representing its depth information is substituted for an α value representing its transmittance when the Z-coordinate value is not greater than a threshold value, so as to make the drawing object transparent. On the other hand, when the Z-coordinate value exceeds the threshold value, a large value is set as the α value to make the drawing object opaque. The Z-coordinate value is set to “0” at the front and is made to increase as the depth increases, as in the first embodiment.

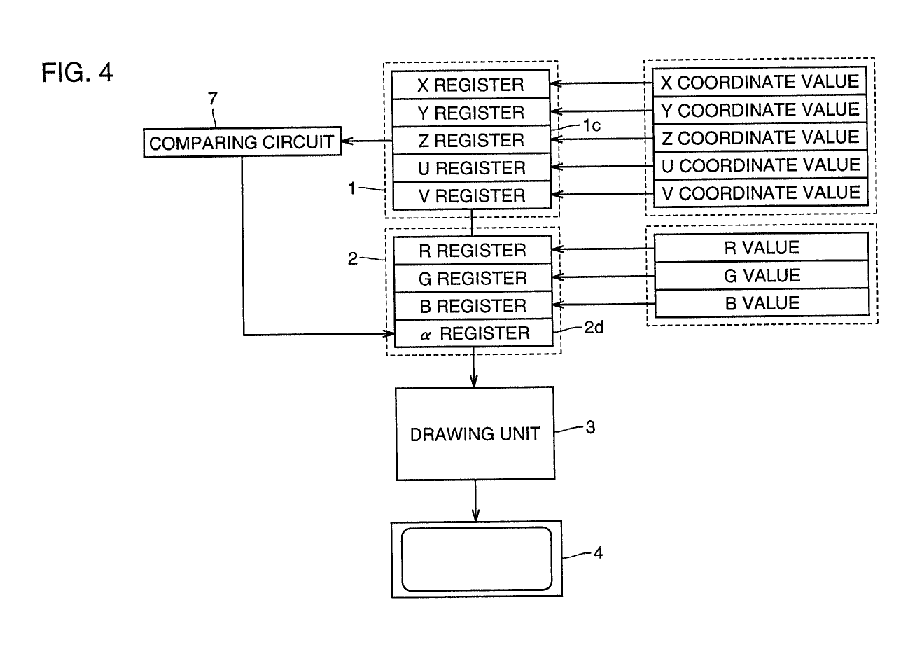

Referring to FIG. 4, the three-dimensional graphics drawing apparatus of the second embodiment includes: a coordinate register 1 in which coordinate values of a drawing object are stored; a color register 2 in which color data of the drawing object is stored; a drawing unit 3 that draws the object based on the coordinate data stored in coordinate register 1 and the color data stored in color register 2; a display unit 4 that displays the object drawn by drawing unit 3; and a comparing circuit 7 that compares a Z-coordinate value stored in a Z register 1c with a threshold value to set a value in an α register 2d. The elements of the present embodiment having the same reference characters as in the first embodiment have the same functions as in the first embodiment.

Comparing circuit 7 compares the Z-coordinate value stored in Z register 1c with a threshold value retained in comparing circuit 7. If the Z-coordinate value is equal to or lower than the threshold value, the Z-coordinate value is set in α register 2d to increase the degree of transparency of the drawing object. If the Z-coordinate value exceeds the threshold value, a large value is set in α register 2d to make the drawing object opaque.

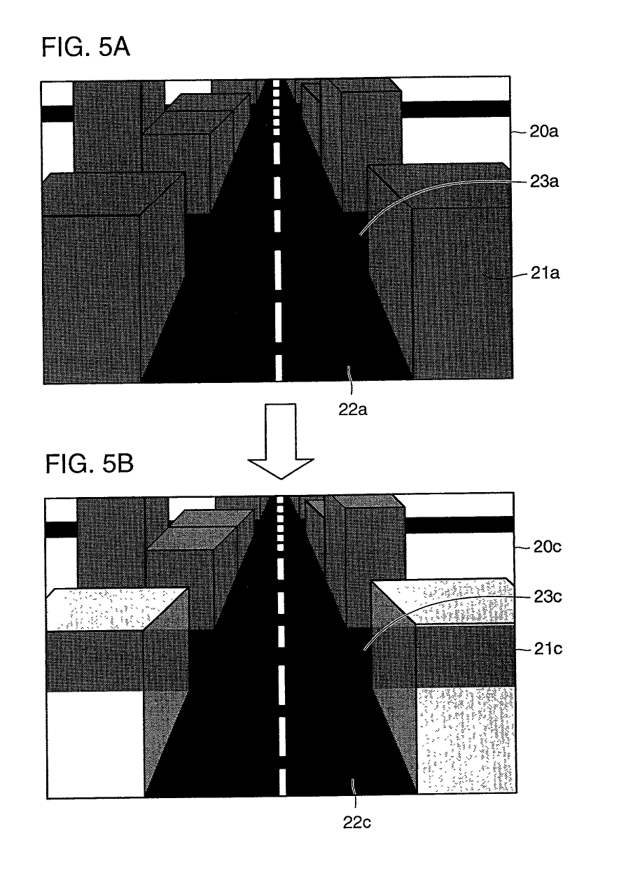

FIG. 5A shows exemplary objects drawn by a conventional three-dimensional graphics drawing apparatus. This is identical to that shown in FIG. 3A, and detailed description thereof is not repeated. FIG. 5B shows the corresponding objects drawn by the three-dimensional graphics drawing apparatus of the present embodiment. On the display image plane 20c, buildings including a building 21c and roads including a road 22c the user is currently following are displayed as the drawing objects. In the three-dimensional graphics drawing apparatus of the present embodiment, the Z-coordinate value is set as the α value of the drawing object when the Z-coordinate value is not greater than the threshold value. Thus, a drawing object close to the front has a low α value and becomes transparent. For example, the detail around the road 23c hidden behind the building 21c can be seen through building 21c. On the other hand, when the Z-coordinate value exceeds the threshold value, a large value is set as the α value of the drawing object. Thus, buildings located farther in depth than building 21c, for example, become opaque.

In the description above, the Z-coordinate value is substituted for the α value when the Z-coordinate value is not greater than the threshold value. More generally, however, the α value can be defined as a monotone increasing function of the Z-coordinate value to obtain the similar effect. For example, if the α value is defined as a linear function of the Z-coordinate value with a positive coefficient, it becomes possible to increase or decrease a ratio of a change of the α value with respect to a change of the Z-coordinate value, thereby setting the degree of transparency of a drawing object more appropriately. In addition, the Z-coordinate value can be set to “0” at the back and made to increase as the depth decreases. In this case, a reciprocal of the Z-coordinate value can be used as the α value when the Z-coordinate value equals or exceeds the threshold value.

As explained above, according to the three-dimensional graphics drawing apparatus of the present embodiment, a drawing object is drawn by setting the Z-coordinate value as the α value of the drawing object when the Z-coordinate value is not greater than a threshold value. Thus, when a viewpoint comes closer to the drawing object, other objects hidden behind the relevant drawing object can be seen through the drawing object, thereby improving visibility. In addition, since the Z-coordinate value is used as the α value of the drawing object, it is unnecessary to retain the α value for every drawing object. This reduces the amount of the drawing data. Furthermore, the effects as described above can be obtained even for a drawing object originally devoid of an α value.

Third Embodiment

In the three-dimensional graphics drawing apparatus of the third embodiment of the present invention, a prescribed value is substituted for color data of a drawing object when the Z-coordinate value of the drawing object representing its depth information is equal to or greater than a threshold value, so that a drawing object located far from the front is prevented from being displayed. In the present embodiment, the Z-coordinate value is set to “0” at the front and is made to increase as the depth increases, as in the third embodiment.

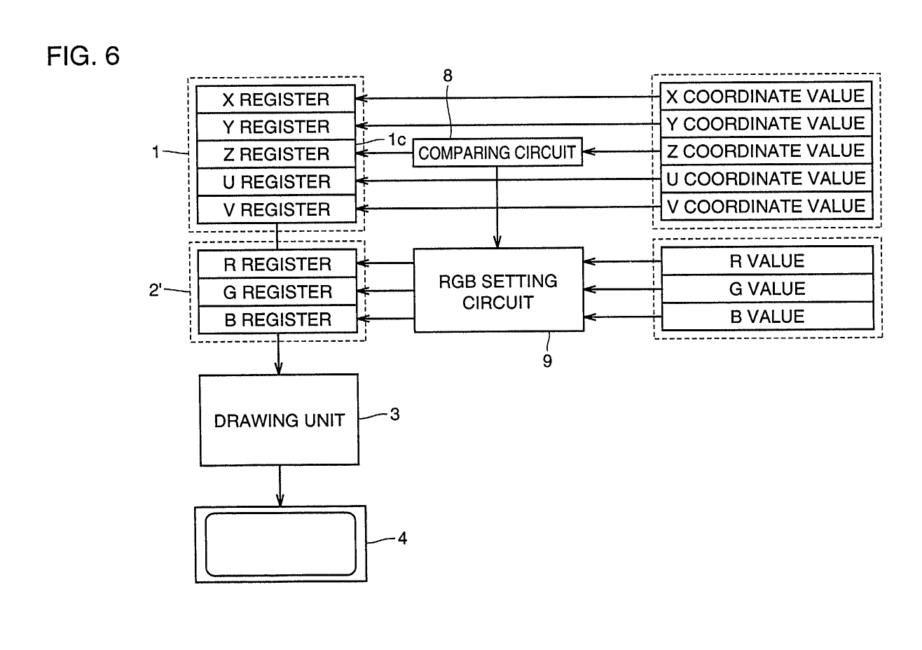

Referring to FIG. 6, the three-dimensional graphics drawing apparatus of the third embodiment includes: a coordinate register 1 in which coordinate values of a drawing object are stored; a color register 2′ in which color data of the drawing object is stored; a drawing unit 3 that draws the object based on the coordinate data stored in coordinate register 1 and the color data stored in color register 2′; a display unit 4 that displays the object drawn by drawing unit 3; and an RGB setting circuit 9 that compares a Z-coordinate value and a threshold value to set a value in color register 2′. The elements of the present embodiment having the same reference characters as in the first embodiment have the same functions as in the first embodiment. Color register 2′ is identical to color register 2 in the first embodiment except that it does not include a register 2d.

Comparing circuit 8 compares a Z-coordinate value of an object and a threshold value stored therein. If the Z-coordinate value is not greater than the threshold value, R, G and B values of the object are set in color register 2′ to allow drawing of the object. If the Z-coordinate value exceeds the threshold value, a prescribed value is set in color register 2′ so as to inhibit drawing of the object. The Z-coordinate value is stored in Z register 1c without alteration.

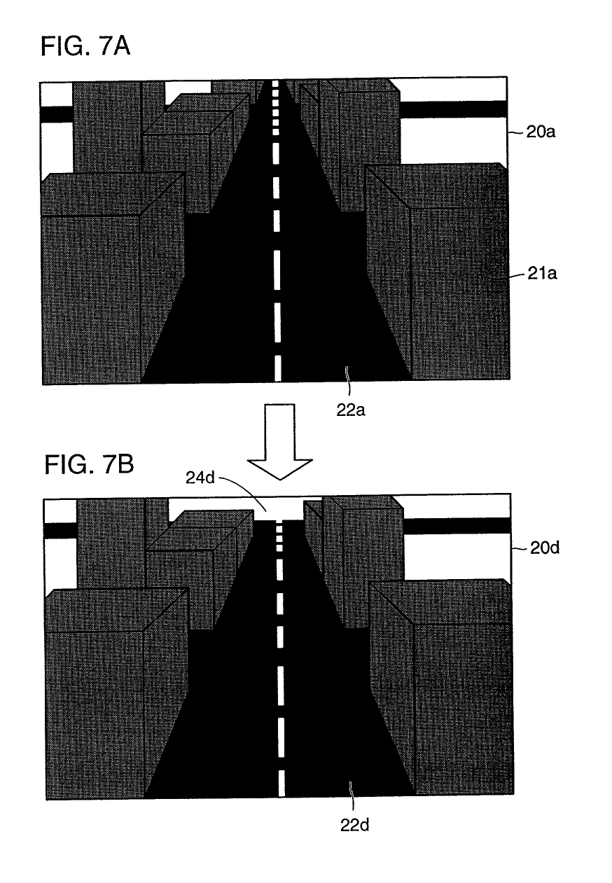

FIG. 7A shows exemplary objects drawn by a conventional three-dimensional graphics drawing apparatus. This is identical to that shown in FIG. 3A, and detailed description thereof is not repeated. FIG. 7B shows the corresponding objects drawn by the three-dimensional graphics drawing apparatus of the present embodiment. On the display image plane 20d, buildings and roads including a road 22d the user is currently following are displayed as the drawing objects. In the three-dimensional graphics drawing apparatus of the present embodiment, the R, G and B values are stored in color register 2′ when the Z-coordinate value is not greater than the threshold value. In this case, drawing objects closer to the front are displayed as usual. When the Z-coordinate value exceeds the threshold value, a prescribed value is stored in color register 2′. In this case, the objects located far from the front, e.g., the buildings near the back and a part of the road denoted by 24d in FIG. 7B, are not displayed. If the values to be set in color register 2′ are selected as (R, G, B)=(0, 0, 0), the corresponding portion near the back will appear as if it is covered by a fog. If large values are selected as (R, G, B), the corresponding portion will look like it is painted black.

As explained above, according to the three-dimensional graphics drawing apparatus of the present embodiment, a prescribed value is set in color register 2′ when the Z-coordinate value exceeds a threshold value. Thus, a visual effect can be realized which allows blackout or whiteout of drawing objects located deeper than a prescribed position. In addition, it becomes unnecessary to draw a small object located farther than the prescribed position, so that processing efficiency of the three-dimensional graphics drawing apparatus is improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A three-dimensional graphics drawing apparatus drawing an object based on color data and coordinate data, comprising:
a transmittance setting unit setting transmittance of the object based on a depth coordinate value included in said coordinate data; and
a drawing unit drawing the object based on the color data including the transmittance set by said transmittance setting unit and said coordinate data.

2. The three-dimensional graphics drawing apparatus according to claim 1, wherein said transmittance setting unit sets the depth coordinate value of the object as the transmittance of the relevant object.

3. The three-dimensional graphics drawing apparatus according to claim 1, wherein said transmittance setting unit uses a monotone increasing function of the depth coordinate value of the object to calculate the transmittance of the relevant object.

4. The three-dimensional graphics drawing apparatus according to claim 3, wherein said monotone increasing function is a linear function of the depth coordinate value of the object with a positive coefficient.

5. The three-dimensional graphics drawing apparatus according to claim 1, wherein said transmittance setting unit uses a reciprocal of the depth coordinate value of the object to calculate the transmittance of the relevant object.

6. The three-dimensional graphics drawing apparatus according to claim 1, wherein
said transmittance setting unit sets the depth coordinate value of the object as the transmittance of the relevant object when the depth coordinate value of the object is not greater than a threshold value, and sets a prescribed value as the transmittance of the object when the depth coordinate value of the relevant object exceeds the threshold value.

7. The three-dimensional graphics drawing apparatus according to claim 1, wherein
said transmittance setting unit calculates the transmittance of the object using a monotone increasing function of the depth coordinate value of the relevant object when the depth coordinate value of the relevant object is not greater than a threshold value, and sets a prescribed value as the transmittance of the object when the depth coordinate value of the relevant object exceeds the threshold value.

8. The three-dimensional graphics drawing apparatus according to claim 7, wherein said monotone increasing function is a linear function of the depth coordinate value of the object with a positive coefficient.

9. The three-dimensional graphics drawing apparatus according to claim 1, wherein
said transmittance setting unit calculates the transmittance of the object using a reciprocal of the depth coordinate value of the relevant object when the depth coordinate value of the relevant object is at least a threshold value, and sets a prescribed value as the transmittance of the object when the depth coordinate value of the relevant object is less than the threshold value.

10. A three-dimensional graphics drawing apparatus drawing an object based on color data and coordinate data including a depth coordinate value, comprising:
a color register storing the color data of the object;
a color data setting unit setting the color data of the object in said color register when the depth coordinate value of the relevant object is not greater than a threshold value, and setting a prescribed value in said color register when the depth coordinate value of the relevant object exceeds the threshold value; and
a drawing unit drawing the object based on the color data stored in said color register and said coordinate data.

11. A three-dimensional graphics drawing method for drawing an object based on color data and coordinate data, comprising the steps of:
setting transmittance of the object based on a depth coordinate value included in said coordinate data; and
drawing the object based on the color data including said transmittance set in the setting step and said coordinate data.

12. The three-dimensional graphics drawing method according to claim 11, wherein said step of setting the transmittance of the object includes the step of setting the depth coordinate value of the relevant object as the transmittance of the object.

13. The three-dimensional graphics drawing method according to claim 11, wherein said step of setting the transmittance of the object includes the step of calculating the transmittance of the object using a monotone increasing function of the depth coordinate value of the relevant object.

14. The three-dimensional graphics drawing method according to claim 13, wherein said monotone increasing function is a linear function of the depth coordinate value of the object with a positive coefficient.

15. The three-dimensional graphics drawing method according to claim 11, wherein said step of setting the transmittance of the object includes the step of calculating the transmittance of the object using a reciprocal of the depth coordinate value of the relevant object.

16. The three-dimensional graphics drawing method according to claim 11, wherein
said step of setting the transmittance of the object includes the step of setting the depth coordinate value of the relevant object as the transmittance of the object when the depth coordinate value of the relevant object is not greater than a threshold value, and setting a prescribed value as the transmittance of the object when the depth coordinate value of the relevant object exceeds the threshold value.

17. The three-dimensional graphics drawing method according to claim 11, wherein
said step of setting the transmittance of the object includes the step of calculating the transmittance of the object using a monotone increasing function of the depth coordinate value of the relevant object when the depth coordinate value of the relevant object is not greater than a threshold value, and setting a prescribed value as the transmittance of the object when the depth coordinate value of the relevant object exceeds the threshold value.

18. The three-dimensional graphics drawing method according to claim 17, wherein said monotone increasing function is a linear function of the depth coordinate value of the object with a positive coefficient.

19. The three-dimensional graphics drawing method according to claim 11, wherein
said step of setting the transmittance of the object includes the step of calculating the transmittance of the object using a reciprocal of the depth coordinate value of the relevant object when the depth coordinate value of the relevant object is at least a threshold value, and setting a prescribed value as the transmittance of the object when the depth coordinate value of the relevant object is less than the threshold value.
